(19) United States
(12) Patent Application Publication
(10) Pub. No.: US 2017/0373870 A1
(43) Pub. Date: Dec. 28, 2017

(54) Multimedia Communication System

(71) Applicants: Senad Hrustanovic, Los Altos, CA (US); Sergio Cherskov, Bothel, WA (US); Vedran Hrenek, San Antonio, TX (US)

(72) Inventors: Senad Hrustanovic, Los Altos, CA (US); Sergio Cherskov, Bothel, WA (US); Vedran Hrenek, San Antonio, TX (US)

(21) Appl. No.: 15/494,566

(22) Filed: Apr. 24, 2017

Related U.S. Application Data
(60) Provisional application No. 62/326,749, filed on Apr. 23, 2016.

(51) Int. Cl. H04L 12/18; G08B 13/196; H04N 7/14; H04M 3/56; H04L 29/06; H04N 7/15

(52) U.S. Cl. CPC H04L 12/1822; H04L 67/38; H04L 29/06027; H04N 7/15; H04N 7/147; H04M 3/567; G08B 13/19645; H04L 65/4076; H04L 65/4038; H04L 63/062; H04Q 2213/1301; H04Q 2213/13248

(57) ABSTRACT

Multimedia communication concept (system) is a new original multimedia communication application software, platform, design and solution. The system may provide an original, standard set of video and VoIP communication and other features which already exist in the market such as, video talks (face to face video talk), Voice communication, IM (text messaging), document and file sharing etc. In addition, the system may add and control more cameras in video communication and elevate an entire video communication experience to the next level. The system may add a new quality and substance in sharing files, documents, pictures, videos, music videos, movies, dedicating a small multimedia window on the UI where user may pull out any of the above files, before deciding to share with another user. The system, with just a simple click on any window, with any content on the UI (file, picture, video, movie, and document) may transfer that content to the other user. The system may include an original control center which controls the entire service and synchronizes work of more cameras (picture and sound) and seamlessly immerses them in each other's living space, manually, by one click on the window on the UI, or by a sensitivity on motion and sound. The system may enable more private groups of contacts, such as immediate family circle, friends and family circle, favorite contacts, interest groups with a full privacy. The system may enable security monitoring service based on continuous motion and audio disturbances in the system.

### CROSS-REFERENCES TO RELATED APPLICATIONS

This application claims the benefit of the U.S. Provisional Application No. 62/326,749 filed Apr. 23, 2016 the disclosure of which is incorporated herein by reference.

### STATEMENT REGARDING FEDERALLY SPONSORED RESEARCH OR DEVELOPMENT

Not Applicable.

### MICROFICHE APPENDIX

Not Applicable.

### BACKGROUND OF THE INVENTION

The inventors frequently used video communication services from the beginning of its existence. They noticed numerous limitations of the existing service:
Being very static, the service puts users in an awkward position of staring into a camera from a very short distance, which is a quite uncomfortable and unnatural position.
Built-in camera is inflexible: it captures only one angle.
Users have to sit all the time in the front of camera in one position to be seen by others on the call
If users move, or even worse, stand up to get something from another room, they have to get away from the screen and leave the call participants, who can now, at best, hear only voice, but cannot see the partner.
If user wants to show anything in the room or from the room, he has to bring it in front of the camera, or move the computer, which will, in both cases, depend on an angle of a built in camera and only partially show it.

The multimedia communication system extends and upgrades the service in which users are able to move around in the room and space and continue conversation with a full visual participation of the other partner in conversation avoiding all the above mentioned unnatural, uncomfortable and limiting situations during video communication.

The above idea was developed gradually in further discussions, but after Aug. 1, 2013, inventors decided to seriously approach development of this idea and assign everybody's role in project development.

### STARTING POINTS

1) Video online communications, video socializing, video meetings, video conference calls, video use of all social media, are definitely a future of communications. Every new improvement of the system and application is beneficial for the customers and society too.

2) Video communication market is just beginning to evolve.

3) At the time, there was only one full scale provider of video communication service and a few others for exclusive clientele, as a side service, limiting communication to an exchange of views from single camera or single multimedia source on each side.

4) Existing services were deemed to be:
very similar,
limited,
static,
not comfortable,
not social,
supporting only face to face conversation on the full screen,
not including the entire atmosphere,
with complicated platforms,
with platforms that are more and more overloaded with features for making money and making users more and more uncomfortable (pop-ups, updates, upgrades are very annoying, they all carry hidden “gotcha” features—collecting private data, collecting pennies, adds, but above all, they are wasting users time),
with platforms that are more and more inclusive of ads and commercials, pop ups, etc.,
with the main service that almost becomes a side feature, lost in money-making features of the platform,
losing freshness, practicality and simplicity, which are important for wider public,
losing focus of quality of main service (video service),
getting overloaded and lost in above mentioned side features,
resulting in service providers with a big bureaucracy and complicated products that are generated by such organization.

5) People are definitely looking for a new quality in communication, a fun and more comprehensive multimedia communication services (not just video), but less complicated and simple for handling.

### THE GOAL OF THE SERVICE

A) To enable users to enter digitally into each other's room/home/living space and surroundings and to experience each other's environment.

B) To elevate online meetings to a new level, with more cameras around a boardroom table. No need any more for moving a plugged-in camera, laptop with the built-in camera, or setting a camera on a distant point in the room to cover the whole room.

C) To enable a new level of socializing online with full experience such as:
watching the same movie together,
listening to the same music,
studying,
virtually socializing,
having family reunions,
participation in kids' life of separated parents,
participation in kids' life when parents are temporarily out of the household,
long distance dating,
alleviating temporary family separation (military, workers, travelers),
alleviating permanent family separations (immigrants).

The proposed service adds a human dimension to online communications, transmits an atmosphere, ambiance where people live, adds new contents to people's communications and socializing, brings people together from vast distances, alleviating separation from friends, families, business partners, businesses, etc.

### SUMMARY OF THE INVENTION

WEB5D is a multimedia communication application software and platform which:

Provides all standard, or expected set of video and VoIP communication and other features, which already exist on the market, such as: video talks (face to face video talk), voice communication, IM (text messaging), face to face business meetings (conference call), socializing, document and files sharing etc.,

Adds and controls more cameras and multimedia sources to communication, combining them together in optional 3D world environment and elevates an entire video/multimedia communication experience to the next level,

Adds a new quality and substance in sharing files such as documents, pictures, videos, music, movies, etc. Dedicated multimedia window which is a part of the UI allows user to select any of the above files, and preview them before deciding to share it with a user on the other side of the link. With a just simple click on the multimedia window, that multimedia stream representing a file (picture, video, music file, movie, or document) can be shared with other users. A discretion is guaranteed, since the user decides what and when he will share with the other parties in communication.

From a technical standpoint, this system significantly upgrades video communications and provides innovative features to capture an entire atmosphere in the user's living space and transmits variety of experiences among users.

The control center synchronizes multimedia sources from multiple local and remote sources (such as live feed from locally attached cameras, web connected cameras, shared user cameras, files, documents, screens, etc.), with or without intermediate aggregation of such multimedia sources in coherent locally or remotely executed 3D rendering living space representations and seamlessly immerses users in each other's living space.

Enables complete privacy and control of privacy by users, providing users with ability to choose the level of information to share with each other.

It opens doors for variety of new applications in different industries, such as the entertainment, film, broadcasting, audio/video industry, etc.

The system also provides a download service to acquire and install client application from Web5D web site (www.web5d.net), to any client devices running Microsoft Windows, Mac or Linux, as well as Android, iOS and Windows Phone smartphones and tablets.

### BRIEF DESCRIPTION OF THE DRAWINGS

FIG. 1.—Two client worlds creating the simplest end to end system

FIG. 2.—User Interface (UI)

FIG. 3.—UI simulation/features

FIG. 4.—Central Service, Infrastructure Topology Overview

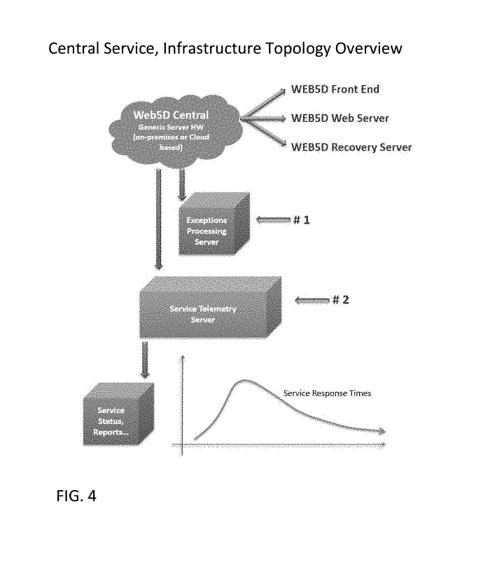

FIG. 5.—Central Service, Infrastructure Topology Details

FIG. 6.—Communications Pipeline

FIG. 7.—Decomposition of client world into input, compute and output devices

FIG. 8.—Linear representation of client world

FIG. 9.—Virtual “flat” 2D representation of input and output devices

FIG. 10.—Compute device's driver for combination of all input sources

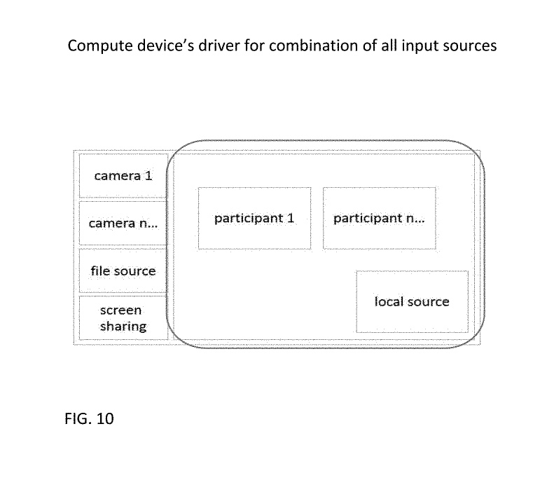

FIG. 11.—Illustration of the “Circles” solution on client's User Interface.

FIG. 12.—Text Messaging Design Illustration

FIG. 13.—Text Messaging Groups

FIG. 14.—Multiple Cameras with motion and Audio detection

FIG. 15.—Burglar Alarm Mode Settings

FIG. 16.—Top (plan) view of Four Lens Web Camera

FIG. 17.—Side view of Four Lens Web Camera

FIG. 18.—Sample of use with Lap-top computer

FIG. 19.—On Lap-top

FIG. 20.—On Ceiling Light

FIG. 21.—Two Head Camera

FIG. 22.—Three Head Camera

### DETAILED DESCRIPTION OF THE INVENTION

Proposed multimedia communication system (service) is a multimedia communication application software and a supporting computer infrastructure comprising a new original design and solutions to:

capture an entire atmosphere of the user's living, or working space with multiple multimedia sources (in one embodiment, comprised of video cameras);

enable sliding pictures from chosen cameras, synchronizing and seamlessly immersing them in users' each other's living or working spaces;

enable private groups of contacts, such as immediate family circle, friends and family circle, favorite contacts, interest groups (such as university, alumni group, company etc.) with full privacy of these selected groups;

allow users to be anonymous only with their default name, if they want use the service but not be registered under Web5D name;

provide also standard expected set of multimedia communication services, IM and video chats, business meetings and socializing, using computers, tablets, smart phones, mobile devices via the Internet;

elevate a quality of meetings and socializing involving more cameras and expand the transmission of 3D space and experience during online communication, family reunion, long distance dating, group study, shared video, or movie, long distance presentations, etc.;

open doors for variety of new applications in different industries, such as entertainment industry, film industry, broadcasting industry, audio/video industry, online learning industry, video game industry, security industry, etc.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, virtual computers, cloud-based computing systems, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The system illustration represents an end to end system with two identical end points, each one having its local system or “world” and accompanying communications pipeline between them.

(NOTE: having only two connected worlds is already a simplification, since ultimately the system is envisioned to work with multiple distributed end points, all simultaneously communicating among themselves).

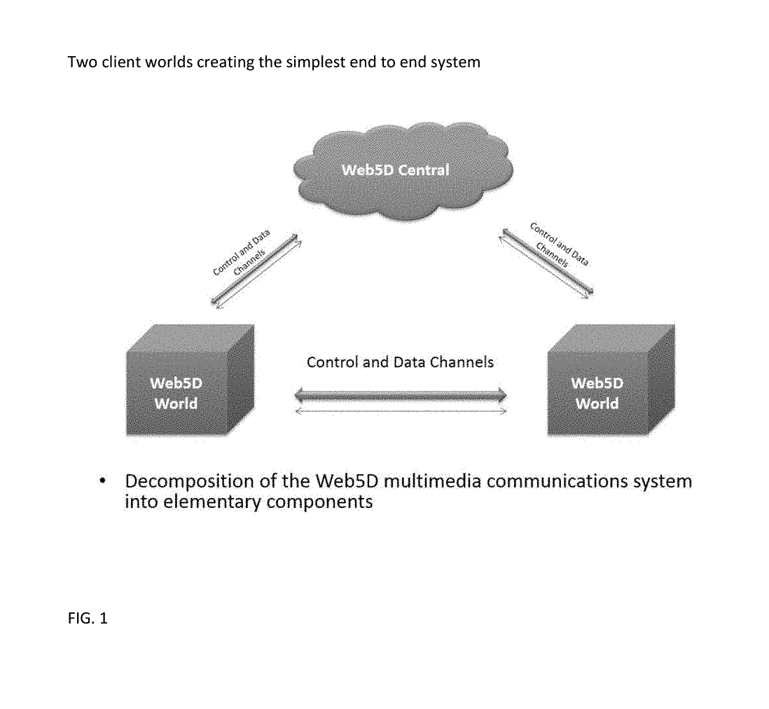

FIG. 1.—Two worlds creating the simplest end to end system

Multimedia communications system, further comprises User Interface (UI), as the new original video communication Control Center UI. UI's main functionality comprises a call establishment and termination, as well as unified view of ever-expanding user's multimedia sources.

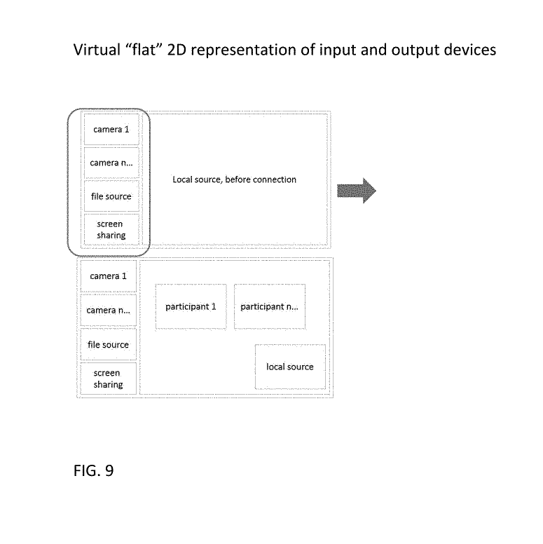

FIG. 9.—Virtual “flat” 2D representation of input and output multimedia devices

In one embodiment, a flat 2D representation arranging input and output devices for effective viewing and user interaction, a series of input device multimedia windows around the edge of the screen and the output device multimedia window in the center of the screen, realized with:

two or more smaller windows on left side of operating system screen;

central large window for video/picture transmitted from the other operating system;

movable window on the bottom of the screen which scrolls up and down. This window is reserved for text messages;

movable window on the right side of the screen which scrolls left and right is designed for lists of users, “who is online” list, etc.

The UI may be comprised of as many small windows as there are connected web cameras or other multimedia data sources, and each displaying a picture from connected camera or other multimedia data source individually. Web cameras are placed in user's chosen space (indoor, outdoor) and connected with an operating system over any number of different connections channels that include and are not limited to USB, Wi-Fi or other wired or wireless networks.

The small multimedia window on the bottom left side of the UI, comprising selectable features and options such as:

a) Share Screen Feature called “SHARE SCREEN”,

b) Display and Share Files feature called “FILE”;

c) Share Online Links feature, called “LINK”, including related feature for displaying adds of major companies and sponsors of the Web5D company;

d) “ADD SOURCES” feature that enables user to connect additional sources, such as public cameras, video files, multimedia sources shared by other devices that current user is logged in, or multimedia sources explicitly shared by other users.

Multimedia sources might comprise multiple cameras that are either connected to user's device or remote in the local room, as well as multimedia file and screen sharing. In addition, other clients on user's local network are detected and their own multimedia sources, if shared, can be transparently used.

With a click of the button, user can select any of the above mentioned multimedia sources, and this window will display multimedia representation of that chosen feature.

With a click on that window, in the same way as on the above windows for individual cameras, local user of the UI is able to send whatever is displayed in that window to the user on other side.

Clicking on any window that displays multimedia source (either pictures from web cameras, displayed in the small windows on the left side of the UI, or additional multimedia sources displayed below), might transmit that particular picture to the other connected users linked with the UI and Control Center.

Illustrations in support of 0001-0027

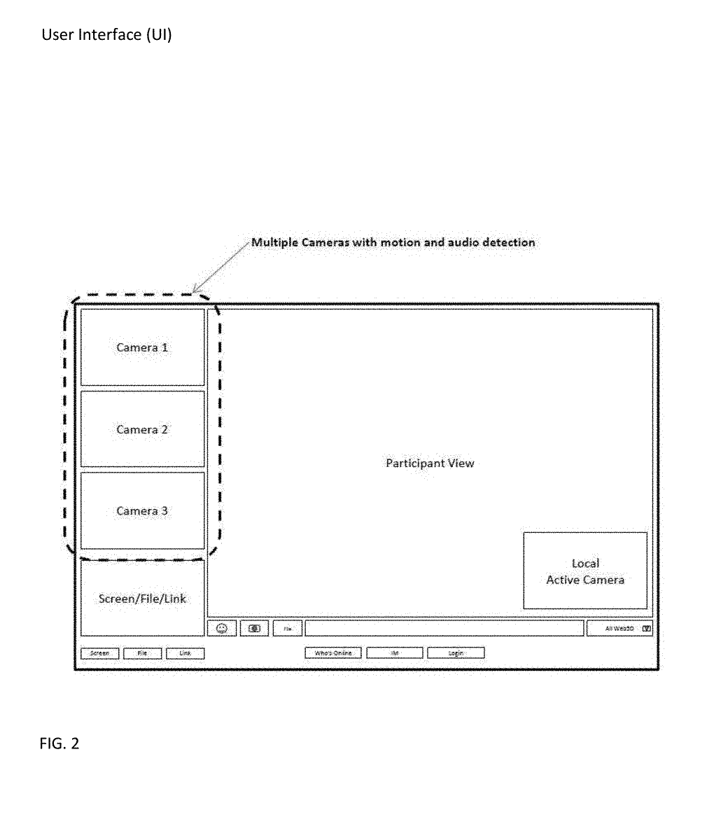

FIG. 2.—User Interface (UI)

In addition to manual selection of multimedia sources, an automatic selection can be specified, based on analysis of movement in video or variations of loudness in audio.

The Control Center client facilitates seamless automatic, or manual selection (sliding) of multimedia sources to the remote recipient on the other side of the connection.

Users may choose to remain anonymous by connecting only with their default one-time only name, if they want to use Web5D without registration. “Anonymous” users (only known to the system with their one-time default name) will not be able to call users who chose to be registered, or to have access to private group “circles”. They will be able to call or be called by other anonymous users only. In addition, registered system users can call other registered system users, depending on called party's acceptance of the call.

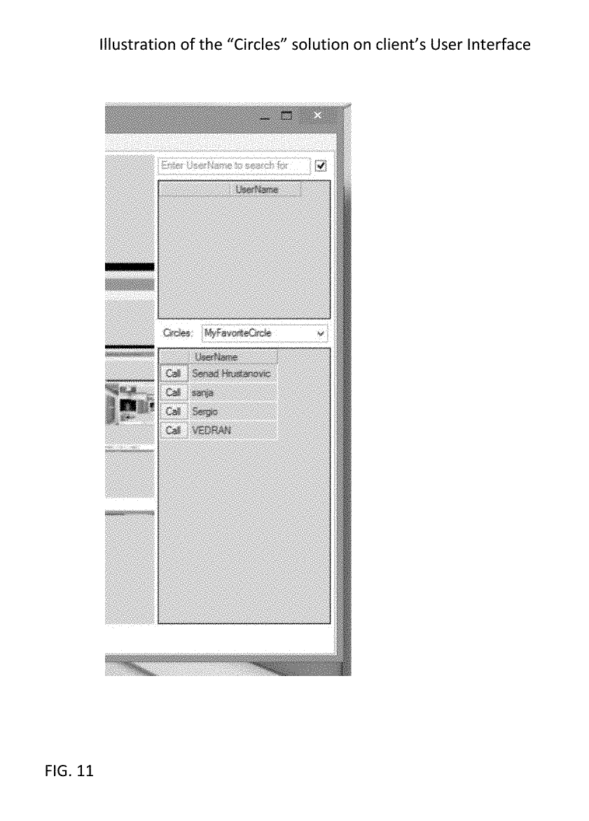

FIG. 11.—Illustration of the “Circles” solution on client's User Interface.

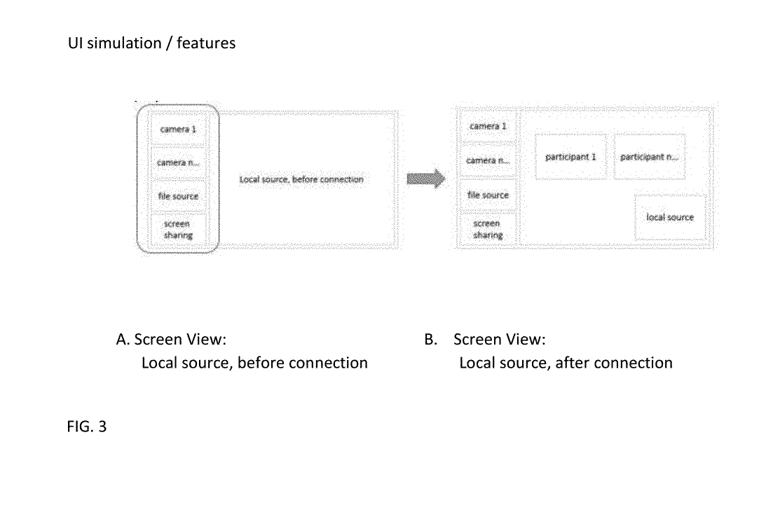

FIG. 3.—UI simulation/features Illustration 1.

Text message (IM) feature may be set up at the bottom of the UI below output display. With one click on IM command, text window may open and may provide standard text features, including but not limited to, insertion of “smiley” characters, insertion of screen snapshots, files, contacts or other multimedia objects. “IM” in addition comprises options for users to define different contact groups and to sort them out in its circles such as: private (immediate family) contacts, “favorites”, “company” or any other group of users' choice. Privacy of the user is enhanced and partitioned, while allowing simultaneous multiple communications with numerous “circles” and corresponding circle users at the same time. A user can have private groups (circles) of contacts which is another way that Web5D text messaging function improves the organization of contacts and users' privacy.

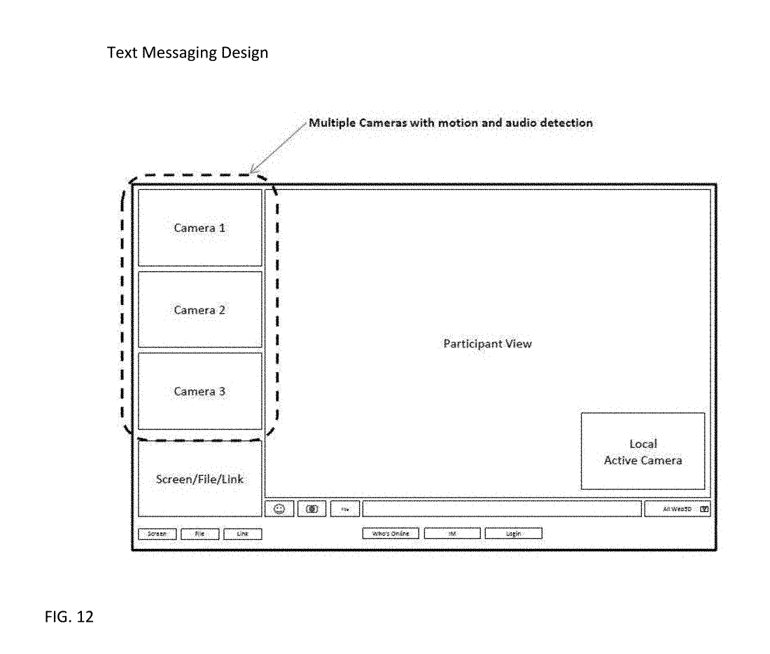

FIG. 12.—Text Messaging Design Illustration

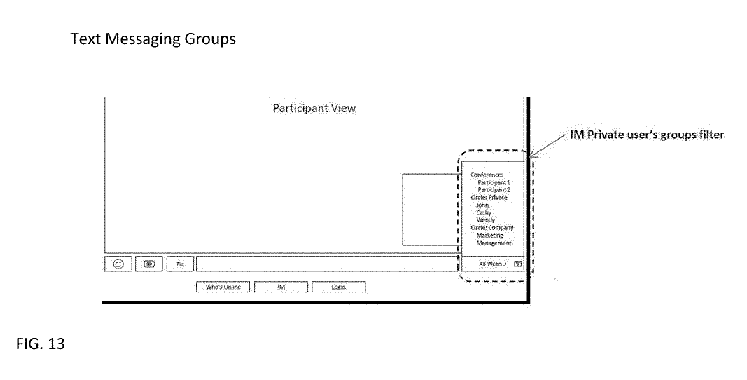

FIG. 13.—Text Messaging Groups

In one embodiment, a security feature called Burglar Alarm may be enabled in UI. Totality of multimedia input devices available to given client may be analyzed for motion and audio changes and features of security system may be implemented. UI may enable multimedia devices such as cameras to provide multimedia feeds that are subsequently analyzed and used to detect intruders when hosts or owners of the house leave the house for vacation, or business trip, by enabling “Burglar Alarm” function on the UI setting and activating corresponding set of services.

In the case of an intruder, UI platform detects a voice or movement in the aggregate 3D world generated by merging of multitude of multimedia sources (such as cameras, microphones, etc.) and sends that information to the control center, which will automatically trigger/alert by utilizing any number of communications channels as provisioned by the system, such as by phone call, or an e-mail to a dedicated administrator, or host, or any other authorized contact in the system.

Illustration of the system:

Cameras are placed in the house for the core of the service (video and audio link) and their pictures are displayed on the screen/user Interface and connected and controlled by the control center.

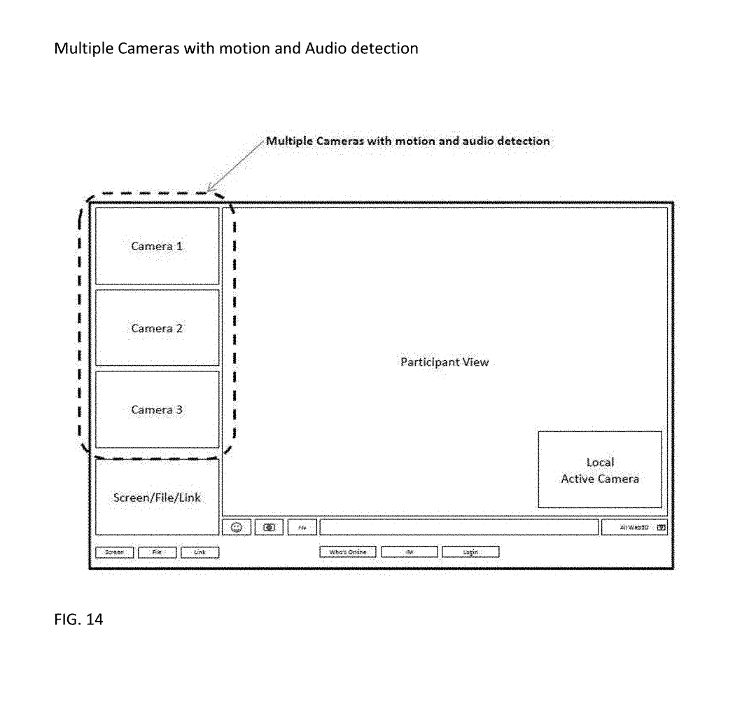

FIG. 14.—Multiple Cameras with motion and Audio detection

UI will pick up movement or voice after we enable “Burglar Alarm” checkbox in the UI Setting.

Illustration 2)

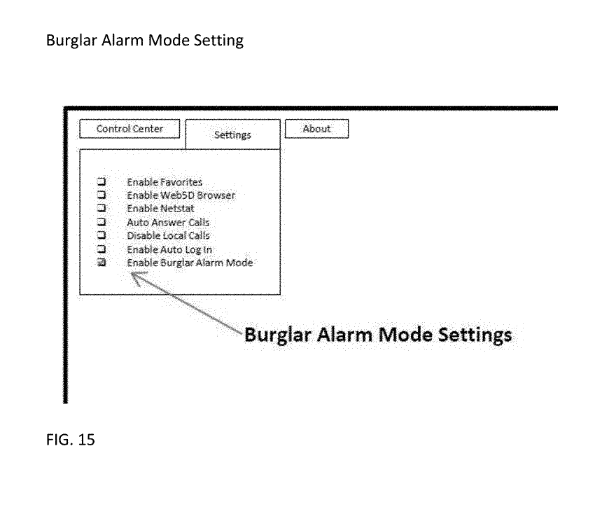

FIG. 15.—Burglar Alarm Mode Settings

Client may be provisioned to sound audio alarm, continuous or at regular intervals, which can be disabled by configuring automatic shutdown after a period of time, with or without manual override, remote or locally on the Control Center. Burglar Alarm function can further be disabled, with code or password, or with unchecking “Burglar Alarm” option in the Setting. In one embodiment of the Burglar Alarm settings, there may be the following three alarm options: e-mail, sound or phone call.

Central Service encompasses scalable instances of:

Event and Heartbeat REST API services Front End Server;

Database repository;

Web Server;

Control Center download service;

Who's Online/IM service;

Universal Service Telemetry Logging with accompanying database repository; Universal Exception Logging Service with accompanying database repository.

Front End Server: Accepts client requests and provides access to the global repository of active users to facilitate multimedia communications. Front End server accepts data from client, processes them in turn and optionally interacts with a repository database as/if required. Repository database queries and calls are further optimized in real-time by the use of Universal Service Telemetry service, built transparently into every computing device. Associated recovery and cleanup services ensure continuous and smooth running of overall Central processing hub.

List of services (provided through REST API as well as SOAP calls) include heartbeat, instant messaging (IM), call events, sharing events, expansion events as well as expansion services.

Heartbeat service uses both an explicit message to establish heartbeat, as well as any individual event exchanged between the device and the system. As devices access the REST API, they are and are added to the “online” list of clients. Specific to Heartbeat message only, additional debug telemetry also comes in with the Heartbeat message that aids with common debugging issues (out of memory, web client distinction, etc.)

“Who's Online” REST API service provides a list of clients that are currently online to devices within the system. Filters may be applied to limit visibility of global clients to selectable contact lists: Contacts, Teams, and Associations.

IM (Instant Messaging) REST API service provides a global messaging exchange and allows for creation of private room conversations (1-1, n-n), as well as broadcast applications (teacher/student 1-n scenarios)

Events service encompasses a set of messages that provide event-driven processing of multimedia communications among clients and include but are not limited to: call events (CALL, ANSWER, ACCEPT, DROP, TRANSMIT, LISTEN, etc.), sharing events (SHARE, FILE, FORWARD, etc.), expansion events (generic events, capable to accept future messages related to events), and expansion services (generic service messages expandable to accept future messages related to services).

Web Server: Generic scalable and expandable web server that provides online functionality for web browser access to following methods:

“Who's Online”—Visualizing a list of global online users, able to be filtered by desired visibility, based on identity and/or locality of web user;

“IM” (Instant Messaging)—Visualization and access to chat service among global users as well as locally configurable sub-groups of users;

Download of client application with auto-detection of web client OS type and delivery of appropriate application (Windows vs iOS vs Android, etc.);

Access to Contact and extended company and application information;

Replicating Control Center functionality within a web browser environment.

Universal Service Telemetry and Exception services: Built-in into every client computing device to facilitate real-time alerting and adjustments of service to be able to efficiently monitor and conform to stated service SLAs (Service Level Agreements). Service includes:

Telemetry: collection, processing and reporting of service duration times and failures;

Exception: collection, processing and reporting of service terminal events and crashes during normal use.

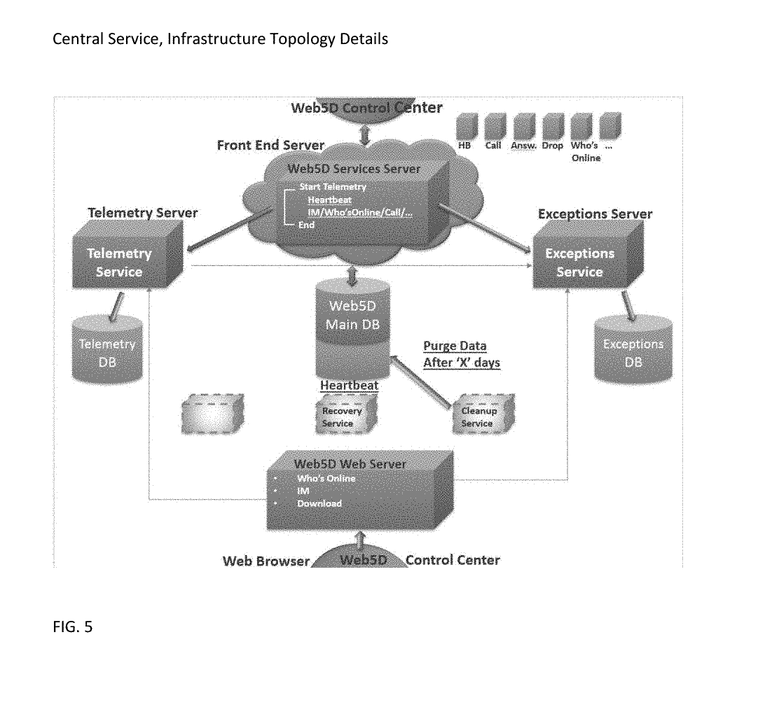

FIG. 5.—Central Service, Infrastructure Topology Details

Communications pipeline contains distinct control and data channels:

Control channel(s)—one or more control channel(s) that enable communications amongst multiple control services that send commands to connected world using common system's command protocol. Depending on connected world privacy settings, all or subset of available commands can be exercised. Common control functionality includes remote selection of input points, output points, positioning of virtual viewpoint in 3D, individual camera movements and adjustments, audio adjustments, system telemetry, user registration and logging, etc.

Local control channel(s) define a communications protocol to discover, connect to and both receive and transmit data on peer-2-peer basis to the other clients on a local network, without involvement of the Central Services. Clients advertise themselves on local network and independently establish communication in those cases where central system facilities are down or not reachable from current network.

Proxy Control Channel(s): Pursuant to user desires for client configuration, an instance of the client can serve as proxy for other clients that don't have direct system accessibility. Proxy does not interfere with any communication and just passively forwards data across between client and system's central servers.

Global Control Channel(s): Global Control Channels and set of associated protocols truly enable a rich set of multimedia communications services.

Data channel(s): one or more data channels, by default transferring client's world output media information across. Media information can include both live streaming audio and video, as well as static media files in common formats. In addition to combined world output media information, one or more raw or pre-processed input sources can be forwarded across data channel to requesting receiving world that asked for them over control channel (if local client privacy policy allows it).

Data channel communication is always between two or more end client nodes on a peer-to-peer basis, without the need of Central system involvement, thus de-coupling data and processing intensive load from central servers and allowing for greater scalability.

For those situations where router tunneling and peer-to-peer communication is not possible due to restrictions in network architecture, a central set of servers is dynamically allocated to proxy and forward data channel stream between two end points without any knowledge of the transmitted content. In addition, relay or proxy data channel can be configured on the given client to allow other clients' communication when direct link between their networks is not available.

Multiplicity of channels and local port reservations are dynamically allocated to enable serving all aspects of multimedia stream existing now and in the future. Examples include video, audio, subtitles, teletext etc.

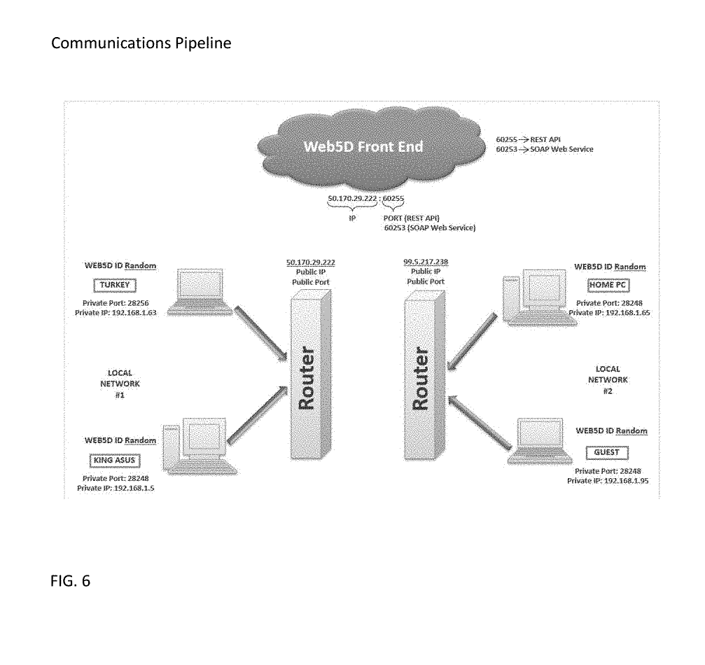

FIG. 6.—Communications Pipeline

Multimedia Device(s): Every client environment (world) consists of and can be split into distinct sets of partial self-contained devices that perform specific functions: input, compute and output.

Input devices—may include any device that provides the source of information for the local (or remote) world. Examples may include one or more cameras, microphones, keyboards, mice, touchscreens, remote smartphones, remote tablets, remote laptops, remote desktops, remote Wi-Fi-connected cameras, etc.

Computing devices—may include any device that receives and aggregates input device(s) media information and with or without additional processing provides a combined output for consumption on output devices. Computing device can reside locally or be located remotely, either in other world(s) or in the Central service cloud. Without loss of functionality, in one particular embodiment, communication pipeline may be considered a part of compute device.

Output devices—may include any device that consumes the output of the computing device after processing. Examples include one or more displays, TVs, located locally or remotely, or communications programs that use multimedia as their inputs (including client itself).

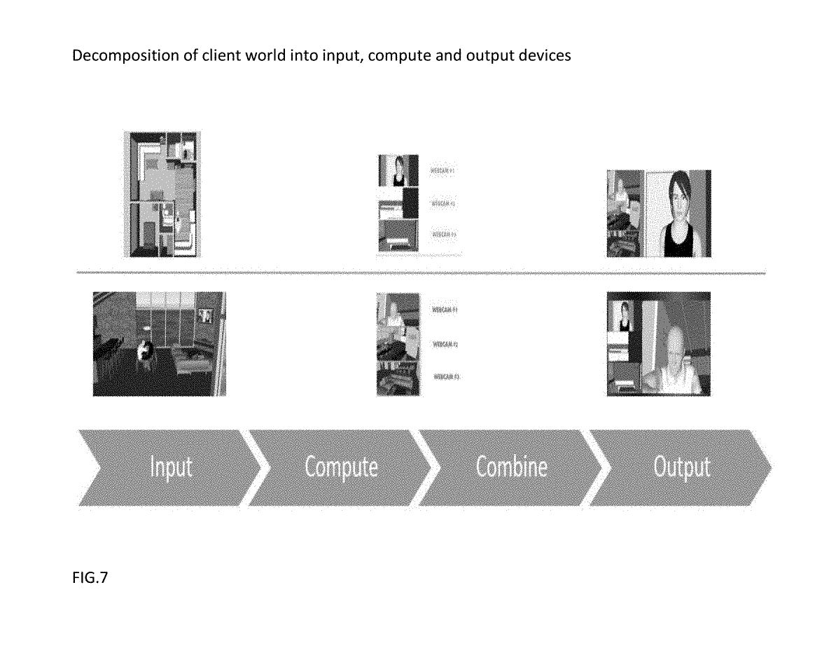

FIG. 7.—Decomposition of client world into input, compute and output devices

Linear representation of client's multimedia system (world) is possible, which decomposes the client multimedia pipeline into input, compute and output devices. It enables a block diagram representation and overall simplification of the concept, without loss of functionality. In the linear view and ultimate simplification, client world can be represented as a left-to-right arrow, with multiple media inputs converging to the system on the left side, encountering compute server that combines them according to one or more proprietary algorithms and then forwards to the other worlds on the right side.

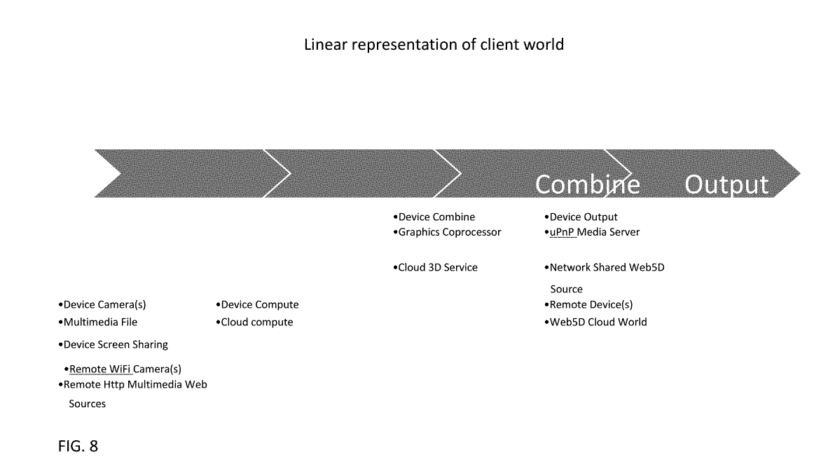

FIG. 8.—Linear representation of client multimedia environment

Thus decomposed and simplified, further client environment refinement development can proceed with a schedule tailored to produce progressively more complex end to end (E2E) fully functioning multimedia pipelines, combining individual multimedia devices as appropriate. Addition of new feature(s) becomes a relatively short iteration for which functional specification can be done locally and executed/validated globally at one or more remote development sites anywhere in the world, if necessary.

A central, cloud-based “Service Combining Multiple Multimedia Input Sources” is proposed that would take multiple input streams and, selectively, in batch, or real-time, combine them to render accurate instance of client world. Such world is then subsequently streamed back to one or more requesting devices where it can be rendered and viewing operated locally or remotely, depending on the underlying scenario. One world realization may be a straight 3D representation of combined camera views, with additional features and ‘dimensions’ provided as extensible services. In the text that follows, “world” and “3D” phrases will be used interchangeably without the loss of meaning.

Scenario 1: Under-powered Device—This is most likely the scenario that will be encountered in common practice. A device having one or more cameras, sends its feeds to the “Service Combining Multiple Multimedia Input Sources” in the cloud where camera views are stitched and 3D world representation is sent back to device for output rendering. On the device, prior to connection, user can then use mouse or touch (or any other applicable) commands to move his view in 3D world. When connected, both sending and receiving users can adjust the view separately on their respective output devices. Depending on protocol selected, connected user can receive his/hers 3D view directly from underpowered device, or from the cloud service. Since cloud service is required (as selected by underpowered device), 3D world is also instantly available for all of the participants in the conversation.

Scenario 2: Multiple devices, user environment—Also quite likely scenario, as user is likely to have more than one device in his/her environment, that are then instructed to send their camera feeds to “Service Combining Multiple Multimedia Input Sources”” in the cloud to get more complete picture of the surroundings. Cameras in question can reside on multiple computers, mobile devices, separate Wi-Fi camera sources, etc. all covering a given area where user moves. In addition, if one of the local devices is powerful enough, it can be used to provide “Service Combining Multiple Multimedia Input Sources”” without the need to send feeds to the external cloud. This sub-scenario is important, as it will be later mentioned, such pre-rendered world can itself be fed to the cloud and further combined with one or more partially rendered worlds or additional camera sources.

Scenario 3: Multiple devices, public environment—In a public setting, such as a public event (presentation, speaking engagement, game, etc.) camera streams from all users are sent to the “Service Combining Multiple Multimedia Input Sources”” in the cloud, which stitches massively large rendering of the 3D world. Even though each camera contributes only a small portion of the final 3D world, each contributing user can get the resulting 3D world feed streamed back to his device and move his viewing position anywhere in the 3D world. This also applies to the connected users as they get to experience the same ability to view and change their particular viewing output position in the rendered 3D world.

Scenario 4: Virtual additions to the worlds created by Web5D Service Combining Multiple Multimedia Input Sources—As “Service Combining Multiple Multimedia Input Sources”” is processing input feeds and creating 3D world feeds, it is anticipated that arbitrary elements can be added to (or removed from) the resulting 3D world feed to enhance user experience. Full alignment of new elements with existing objects in 3D world is anticipated, rendering them indistinguishable from the original setting. Such elements may be (non-exhaustive list):

Additional screens in user environment rooms;

Additional large panels/constructs in public event renderings;

Fitting of desired furniture or space-enhancement acquisition into user environment room;

Additional views into connections to the other 3D worlds that current user is connected to.

Admittedly, the list of possibilities is almost unlimited, and may be further opened to the development community by “3D World Software Development Kit (SDK)” which provides necessary API interfaces, source code examples and demoes of such virtual additions.

Scenario 5: Ease of virtual manipulation and rendering of worlds created by Service Combining Multiple Multimedia Input Sources—Once in “Service Combining Multiple Multimedia Input Sources” format, rendered world can be taken over and incorporated into any number of document-processing software programs. Virtual manipulation of rendered world embedded inside Word document (or PowerPoint presentation) is seamless and can outlive original live feeds if necessary. Again, appropriate set of APIs released as Integration SDK may enable user interaction with rendered Worlds in their favorite applications.

Scenario 6: User with multiple devices—When user has more than one device in his possession on the site/local area (for example, and not limited to: multiple laptops with cameras, smartphones, wireless cameras, tablets, PCs, etc.), and if the user logs on multiple devices, there may be an option provided on the UI, to share cameras from multiple devices and receive pictures from them in a unified view across all UIs involved, that then can be shared (aka ‘sliding’) during the call with other users. All cameras from multiple devices in one space will be engaged and seen on the UI on every one of these involved devices, and each of them can be transmitted (aka ‘sliding’) to another user on the other side, by a choice of users.

In one of the embodiments there may exist a Discovery server, and the mechanism to register and accept new input and output devices into the 3D world, as well as discovery of the remote 3D worlds, through a multitude of discovery algorithms some of which may include:

Auto-detection of multimedia devices additions/deletions from the host system;

Peer to peer discovery protocol of other multimedia devices on local network;

Central Discovery service of other 3D worlds and their multimedia devices;

Cloud-based global discovery and sharing of multimedia devices.

For the purpose of testing the system with multiple cameras, custom-made web cameras may be developed, in one embodiment comprising of two, three and four-lenses.

Four lenses web camera: unique design of web camera with four lens. Camera could have wire or wireless connection to any client devices running Microsoft Windows, Mac or Linux, as well as Android, IOS tablets or smartphones. Significantly upgrades video communication and provides innovative features to capture an entire atmosphere in the user's living or working space and transmit variety of experiences among users. Four lenses are synchronized with video communication application software (client's application) and facilitate seamless automatic or manual selection (sliding) of four lens's field views (FOV) to the remote recipient on the other side of the connection. Easy placement at appropriate location to cover most of the user's living or working space.

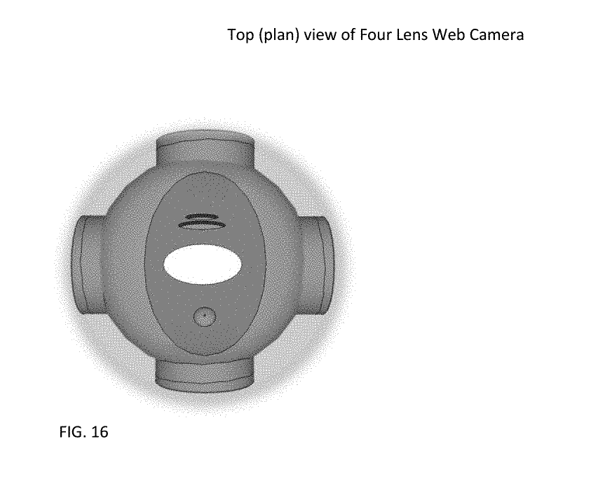

FIG. 16.—Top (plan) view of Four Lens Web Camera

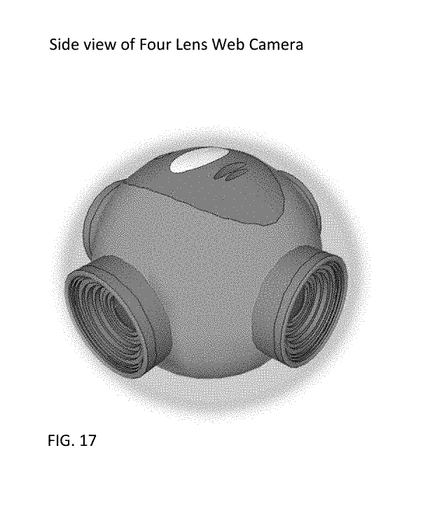

FIG. 17.—Side view of Four Lens Web Camera

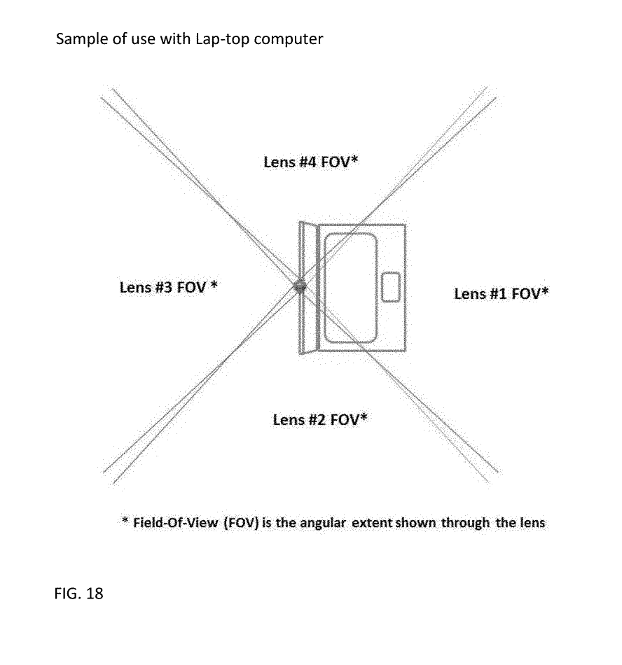

FIG. 18.—Sample of use with Lap-top computer

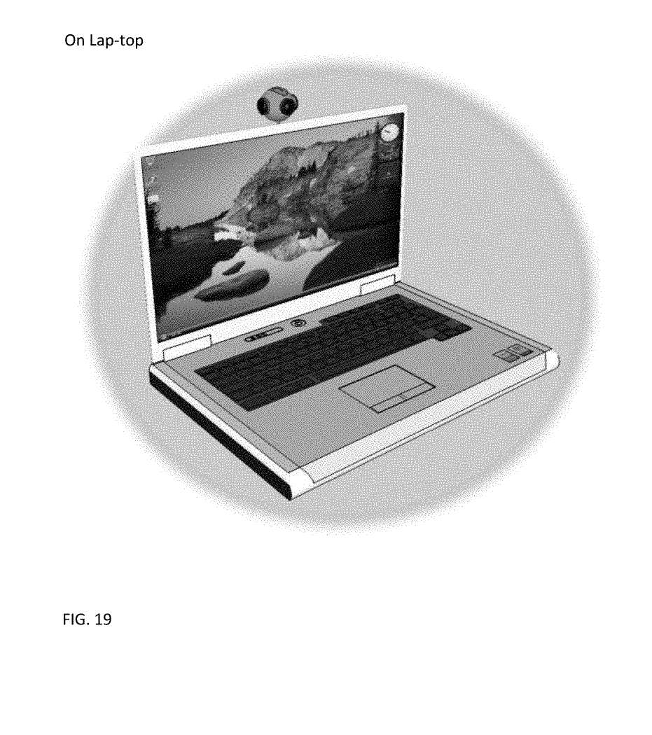

FIG. 19.—On Laptop

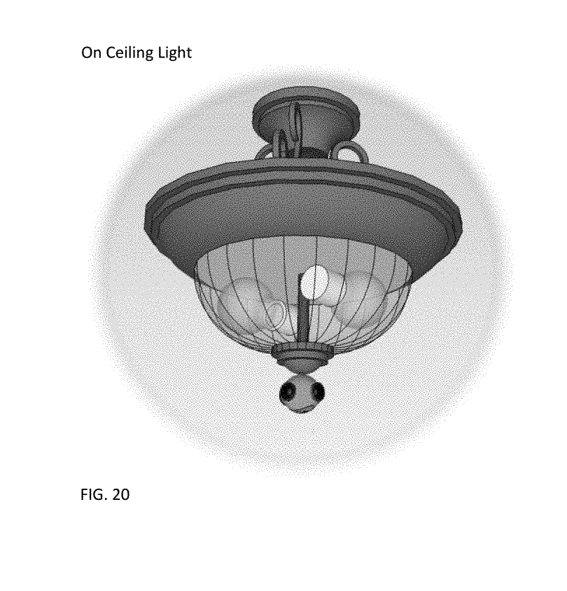

FIG. 20.—On Ceiling Light

Two and three lens cameras: Depending on the user's preferences, combination with existing Laptop or Smartphone camera, web camera may have two or three lenses that may be synchronized with video communication application software (client's application), providing a 360 degrees view of the entire surroundings that can be used by the system to recreate 3D depiction of the space.

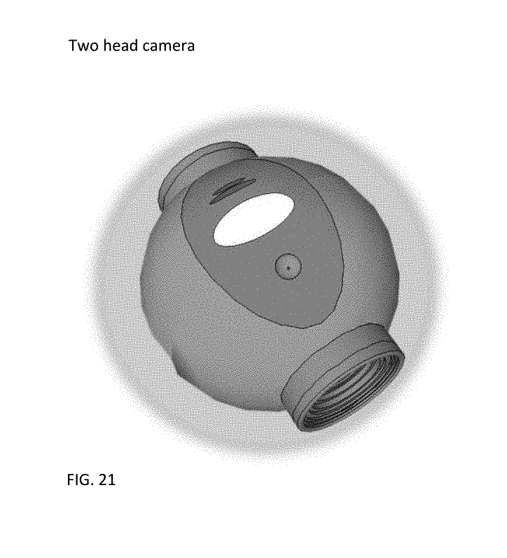

FIG. 21.—Two Head Camera

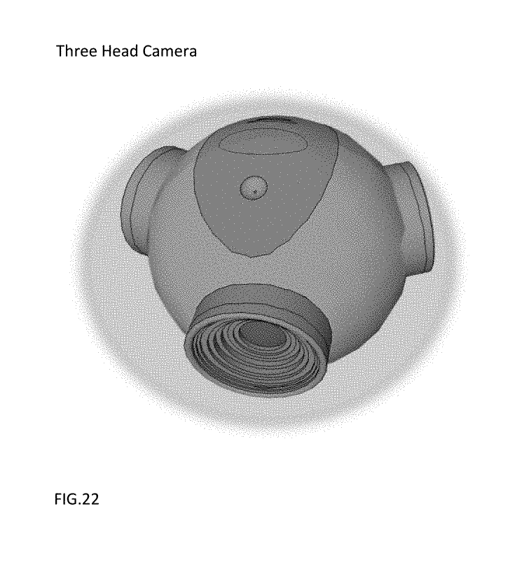

FIG. 22.—Three Head Camera The present invention may be embodied in other specific forms without departing from its spirit or essential characteristics.

The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. At a computer system including a processor and a memory, in a computer networking environment including a plurality of computing systems, a computer-implemented method for multimedia communication system, the method comprising:
an act of capturing an entire atmosphere of the user's living or working space in 3D world, utilizing multiple simultaneous instances of multitude of multimedia sources, which may include but are not limited to built-in, plugged-in or network connected cameras, file sources, and other device or network connected multimedia sources (including output of other multimedia communication systems);
an act of selecting (aka “sliding”) streams from chosen multimedia sources to multitude of recipient users (regardless of the mode of selection, either manually or automatically); and
an act of rendering multitude of multimedia sources on available output multimedia devices at local user's environment, regardless if multimedia sources originated locally or remotely.

2. The method of claim 1, wherein rendering of multitude of multimedia sources creates a virtual “flat” 2D representation, where input multimedia devices are in one conceptual instance visualized as series of video windows around the edge of the screen, with the output multimedia device visualized and displayed in the center of the screen.

3. The method of claim 1, further comprising an act of grouping users in privacy enhanced circles, wherein exchange of multimedia streams is securely limited to circle members.

4. The method of claim 1, further comprising an act of discovering new input and output multimedia sources for inclusion into the 3D world, as well as discovery of remote 3D worlds, through a multitude of discovery algorithms some of which may include auto-detection of multimedia devices additions/deletions from the host system, peer-to-peer discovery of other multimedia devices on local network, central discovery service of other 3D worlds and their multimedia devices, or cloud-based global discovery and sharing of multimedia devices.

5. The method of claim 4, further comprising an act of previewing discovered multimedia sources in dedicated multimedia window which may be a part of one UI embodiment, wherein discretion is guaranteed, since the user can decide what and when will be shared with other parties in the communication, wherein discovered multimedia sources may include but are not limited to multimedia files, multimedia representation of general document files, remote multimedia streams, multimedia representation of current user screens, and multimedia representations of web pages.

6. The method of claim 4, further comprising an act of selecting previewed multimedia sources for sharing with other users or circles, wherein selection is accomplished by multitude of actions including but not limited to clicking on the window, tapping on the window, swiping the window, voice command, or by remotely connected users.

7. The method of claim 1, further comprising an act of registering newly discovered input and output multimedia sources so their multimedia stream can be snared transparently and securely.

8. The method of claim 1, wherein an act of capturing an entire atmosphere may be performed by deviating from 3D representation of multimedia content in Cartesian coordinates while still preserving individual multimedia streams in resulting 3D world, wherein such 3D world may enable smaller storage requirements as well as faster transmission speeds.

9. The method of claim 1, further comprising an act of utilizing compute device algorithm(s) for detecting motion or audio change in multimedia streams, detecting and selecting appropriate multimedia stream amongst many people talking and moving in the 3D rendered world of multimedia devices.

10. The method of claim 1, further comprising an act of utilizing compute device that combines multiple input multimedia sources with or without additional processing and presents combined output multimedia stream for consumption on output devices.

11. The method of claim 1, further comprising an act of moving a virtual camera view position in rendered 3D world that can then subsequently be streamed to multitude of connected devices and further analyzed, wherein 3D world can still be interpreted as a multitude of discrete individual multimedia sources or fully integrated and rendered as single virtual multimedia entity.

12. The method of claim 1, further comprising an act of moving a virtual camera view position in received rendered 3D world, wherein the position of the virtual camera view on receiving side is independent from the virtual camera view on the sending side, wherein 3D world can still be interpreted as a multitude of discrete Individual multimedia sources or fully integrated and rendered as single virtual multimedia entity.

13. The method of claim 1, further comprising an act of analyzing multimedia streams, either from unaltered multimedia sources or captured 3D world, for motion or audio disturbances, with or without utilization of method of claim 11 to move the virtual camera view to better visualize and describe the source of disturbance.

14. The method of claim 13, further comprising an act of sending alerts to multiple simultaneous destinations, which may include but Is not limited to email, SMS, phone, sound device, log file, circles, or web service.

15. A computer program product for implementing a method for multimedia communication system, the computer program product comprising one or more computer-readable storage media having stored thereon computer-executable instructions that, when executed by one or more processors of the computing system, cause the computing system to perform the method, the method comprising:
an act of capturing an entire atmosphere of the user's living or working space in 3D world, utilizing multiple simultaneous instances of multitude of multimedia sources, which may include but are not limited to built-in, plugged-in or network connected cameras, file sources, and other device or network connected multimedia sources (including output of other multimedia communication systems);
an act of selecting (aka “sliding”) streams from chosen multimedia sources to multitude of recipient users (regardless of the mode of selection, either manually or automatically); and
an act of rendering multitude of multimedia sources on available output multimedia devices at local user's environment, regardless if multimedia sources originated locally or remotely.

16. The computer program product of claim 15, wherein virtual camera views from rendered 3D worlds are made available as multimedia streams for embedding into and consumption by other computer program products, which might include but are not limited to MS Office, on any client device that might be running any of operating system, examples of which include but are not limited to Microsoft Windows, Linux, Android, and iOS.

17. A computer system comprising the following:
one or more processors;
system memory;
one or more computer-readable storage media having stored thereon computer-executable instructions that, when executed by the one or more processors, causes the computing system to perform a method for multimedia communication system, the method comprising:
an act of capturing an entire atmosphere of the user's living or working space in 3D world, utilizing multiple simultaneous instances of multitude of multimedia sources, which may include but are not limited to built-in, plugged-in or network connected cameras, file sources, and other device or network connected multimedia sources (including output of other multimedia communication systems);
an act of selecting (aka “sliding”) streams from chosen multimedia sources to multitude of recipient users (regardless of the mode of selection, either manually or automatically); and
an act of rendering multitude of multimedia sources on available output multimedia devices at local user's environment, regardless if multimedia sources originated locally or remotely.

18. The method of claim 17, wherein compute device combines multiple input multimedia sources as 3D world, with or without additional processing and presents combined output multimedia stream for consumption on output devices.

19. The method of claim 18, wherein compute device resources can be obtained locally or remotely as a service running in the cloud.

20. The method of claim 18, wherein remote compute device resources can be used to store and distribute processed combined input multimedia stream in a form of multimedia 3D world to multitude of connected users, wherein 3D world can still be interpreted as a multitude of discrete individual multimedia sources or fully integrated and rendered as single virtual multimedia entity.
